(19) United States
(12) Patent Application Publication
(10) Pub. No.: US 2008/0319982 A1
(43) Pub. Date: Dec. 25, 2008

(54) Method and Apparatus for Manipulating Data Files

(75) Inventors: Donghai Yu, Shanghai (CN); Hairong Yuan, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/096,805

(22) PCT Filed: Dec. 11, 2006
(86) PCT No.: PCT/IB06/54725

§ 371 Date: Jun. 10, 2008

(30) Foreign Application Priority Data
Dec. 14, 2005 (CN) 200510131476.X

(51) Int. Cl. G06F 17/30

(52) U.S. Cl. 707/5; 707/101; 707/E17.017; 707/E17.009

(57) ABSTRACT

A method of encoding a data file stored in a storage unit, said method comprising the steps of:—extracting (100) a non-alphabetical data from said data file, said data being associated with said file;—converting (101) said data into a word in using symbols taken from a first set of symbols; and—encoding (102) said word with a look-up table for generating index data (320), said look-up table associating said symbols with a second set of symbols, each symbol of said second set of symbols being associated with a subset of said first set of symbols.

### FIELD OF THE INVENTION

The invention relates to a data file manipulating method and apparatus, and more particularly to a media files manipulating method and apparatus.

### BACKGROUND OF THE INVENTION

With the falling cost and enhanced capability of storage in consumer electronic devices, consumers handle a large number of files stored in a storage unit. For example, in the field of digital entertainment, consumers may store a lot of media files on Media Centers, jukeboxes or MP3 players. A 40-100 GB storage capacity is not rare in today's MP3 player market, allowing the user to store over 10,000 MP3 songs in one player.

Besides the local storage, the development of connectivity allows consumers to access huge network/remote storage.

At the same time, media collections include multi-language contents, for example, Chinese songs, English songs, French songs, Japanese songs. Known methods of searching or sorting treat the different language separately, meaning that users have to select language input mode before they input a query for searching a given media file.

On the other hand, CE devices are typically controlled by a remote control or other limited control keys. These devices often include a keyboard that has fewer keys than letters in the alphabet for the associated language. For example, many of the devices using reduced keyboards use a three-by-four array of keys as used on a Touch-Tone telephone.

The large media database and the limited control/display capability cause lots of problems to browse through media collections or to locate a specific medium from a long list. This typically requires many key presses and requires that the user be sure of the media name he is looking for, which complicates the search.

Various appoaches have been developed for entering and displaying desired text using reduced keyboard. For example, Patent application US20020126097 discloses a method and apparatus for inputting alphanumerical data into an electronic device via a reduced keyboard using context-related dictionaries. U.S. Pat. No. 6,307,548B1 provides a reduced keyboard disambiguating system.

However, the above-mentioned prior arts do not provide a solution to the use of a unified input method regardless of the language mode difference for searching a target file.

### OBJECT AND SUMMARY OF THE INVENTION

It is an object of the invention to propose an improved method for encoding a data file in order to facilitate the search in a storage unit.

This object is achieved in a method of encoding a data file stored in a storage unit, said method comprising the steps of extracting a non-alphabetical data from said data file, said data being associated with said file; converting said data into a word in using symbols taken from a first set of symbols; and encoding said word with a look-up table for generating index data, said look-up table associating said symbols with a second set of symbols, each symbol of said second set of symbols being associated with a subset of said first set of symbols.

This object is also achieved in an apparatus of encoding a data file stored in a storage unit, said apparatus comprising an extracting means for extracting a non-alphabetical data from said data file, said data being associated with said file; converting means for converting said data into a word in using symbols taken from a first set of symbols; and encoding means for encoding said word with a look-up table for generating index data, said look-up table associating said symbols with a second set of symbols, each symbol of said second set of symbols being associated with a subset of said first set of symbols.

It is another object of the invention to propose an improved method of retrieving data files stored in a storage unit.

The object is achieved in a method of retrieving data files stored in a storage unit, each of said files being associated with index data, said method comprising the steps of generating a word in using symbols taken from a first set of symbols; encoding said word with a look-up table for generating an encoded data, said look-up table associating said symbols with a second set of symbols, each symbol of said second set of symbols being associated with a subset of said first set of symbols; and searching all data files that have index data matching said encoded data.

This object is also achieved in an apparatus of retrieving data files stored in a storage unit, each of said files being associated with index data, said apparatus comprising: generating means for generating a word in using symbols taken from a set of characters; encoding means for encoding said word with a look-up table for generating an encoded data, said look-up table associating said symbols with a second set of symbols, each symbol of said second set of symbols being associated with a subset of said first set of symbols; and searching means for searching all data files that have index data matching said encoded data.

Therefore, this invention provides a solution to handling different languages in a language-independent way for manipulating data files, meanwhile, it provides a solution to searching data files without knowing exactly the query content.

Other objects and attainments together with a fuller understanding of the invention will become apparent and appreciated by referring to the following description and claims in conjunction with the accompanying drawings.

### BRIEF DESCRIPTION OF THE DRAWINGS

The invention will be described with reference to the accompanying drawings in which:

FIG. 1 shows a flowchart of the method for encoding a non-alphabetical data file according to the invention.

FIG. 2 shows a flowchart of retrieving data files in a storage unit according to the invention.

FIG. 3 illustrates a structure of a data record format according to the invention.

FIG. 4 depicts a look-up table used in the method according to the invention.

FIG. 5 represents an apparatus for encoding a data file stored in a storage unit according to the invention.

FIG. 6 represents an apparatus for retrieving data files stored in a storage unit according to the invention.

In these figures like parts are identified by identical references.

### DETAILED DESCRIPTION OF THE INVENTION

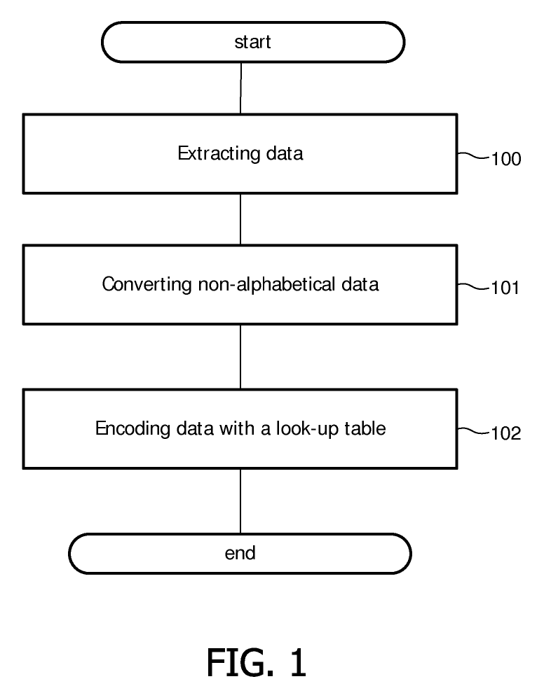

FIG. 1 shows a flowchart of the method for encoding a non-alphabetical data file according to the invention.

The invention provides a method of encoding a data file stored in a storage unit, said method comprising the step 100 of extracting a non-alphabetical data, and said data being associated with said file. When a new data file is stored in a data file storage unit, the data associating with the file is extracted in step 100, wherein the data may comprise keywords of the file or metadata of the file, e.g. ID3 tags of an MP3 file, or Exif data of a picture. For example, with a data file corresponding to a Chinese song titled [symbol] and stored in an MP3 player, text word [symbol] is extracted by step 100.

The method also comprises the step 101 of converting said non-alphabetical data into a word in using symbols taken from a first set of symbols. Because the extracted data may be alphabetical or non-alphabetical (such as Chinese, Korean and Japanese), the non-alphabetical data is converted in step 101 into a word in using symbols taken from a first set of symbols, which may be 26 English alphabetical characters of A, B, C, D, E, F . . . Z. Any Simplified Chinese character or Traditional Chinese character can be converted into “PINYIN” symbol, and any Korean character can be converted into a “Jamos” symbol. So, in step 101, non-alphabetical characters” [symbol] are converted into their” PINYIN” form “zhifeiji”.

The method also comprises the step of 102 of encoding said word with a look-up table for generating index data 320, said look-up table associating said symbols with a second set of symbols, each symbol of said second set of symbols being associated with a subset of said first set of symbols.

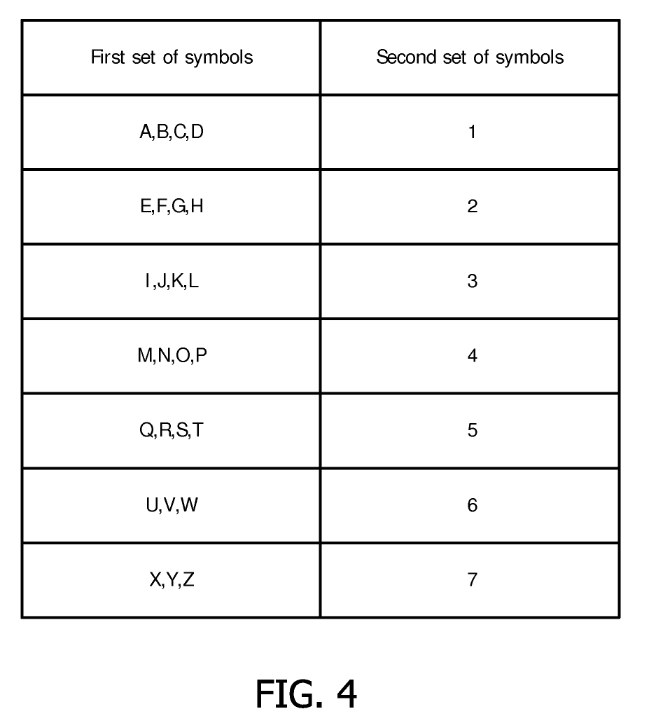

After step 101, the non-alphabetical data is converted into a word. In step 102, the word is encoded with a look-up table for generating index data 320. A look-up table is illustrated in FIG. 4. In accordance with the example above, in step 102, the word “zhifeiji” is encoded according to a look-up table, as shown in FIG. 4. If using this table, the encoded data, called index, is “72322333”.

FIG. 4 depicts a look-up table used in the methods according to the invention. In this table, the left column represents a first set of symbols: A, B, C, D, E, F . . . Z, and the right column represents a second set of symbols, 1, 2, 3, 4, 5, 6, 7. Obviously, those symbols could be any other symbols. Each symbol of the second set of symbols is associated with a subset of the first set of symbols, for example. Symbol “1” is associated with A, B, C, D and Symbol “2” represents E, F, G, H. Obviously; the corresponding subset of the first set of symbols may vary.

Additionally, the invention provides a method comprising the step (not shown) of generating a data record, said data record comprising said index data 320 and a file pointer, said file pointer linking said data record with said file and the step of storing said data record in a database.

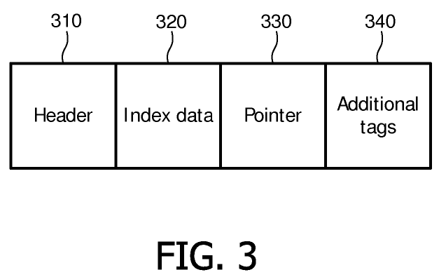

FIG. 3 illustrates the structure of a data record format according to the invention. Said data record comprises index data 320 and a file pointer 330, said file pointer 330 linking said data record with said file, then the data record is stored in a database. Pointer 330 can be the storage position (i.e. address) of the file or a reference to the platform through which the application can locate the file that this data record represents. Additional tags 340 are any other tags to fine-classify the file content e.g. the language, category, personal favorite mark etc. Using how many tags and what kinds of tags are optional and application-dependent. This invention can also locate files with different categories, e.g. “album_name”, “artist_name”. For each category, a data record is created and added to the database. To identify the different search categories, the category information can be added to the data record “Additional Tag” 340. The header 310 is a pre-defined label to mark the start of a new record.

Moreover, the invention provides a method comprising the step (not shown) of generating a plurality of data records, each of said data record containing one substring of said index data 320. Suppose a file with title “ABC DEF GHI”, of which corresponding index data 320 are “111 122 223”. The following three substring of index data 320 are produced:

$$\begin{matrix} 111 & 122 & 223 \\ 122 & 223 & \\ 223 & & \end{matrix}$$

Therefore, three data records are generated. Each of them contains one substring of index data 320. All three data records are related to the file titled “ABC DEF GHI” by using pointer 330 respectively. Therefore, this method also provides a substring encoding method.

On the other hand, when said index data 320 comprise a plurality of sets of symbol, this invention provides a method comprising the step of generating derived index data by concatenating each first symbol of each set of symbols. In the example above, derived index data 112 are generated by concatenating each first symbol of each set of symbols 111 122 223.

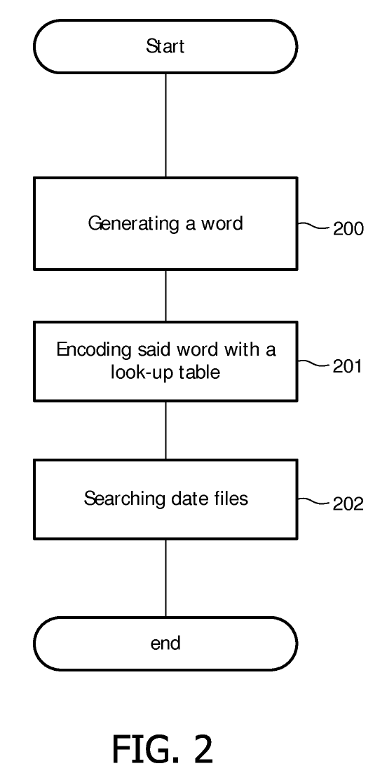

FIG. 2 shows a flowchart of retrieving data files in a storage unit according to the invention.

The invention provides a method of retrieving data files stored in a storage unit, each of said data files being associated with index data 320, said method comprising the step 200 of generating a word in using symbols taken from a first set of symbols. In the step 200, a query is generated to search a specific data file stored in a storage unit, each of said files being associated with index data 320. If the query is non-alphabetical, it should be previously converted into a word in using symbols taken from a first set of symbols, which may be 26 English alphabetical characters A, B, C, D, E, F . . . Z. Here is an example, if the user wants to find a Chinese song entitled “ [symbol] , he may use PINYIN form “zhifeiji”. In most cases, the user does not need to input the complete string, usually, he just needs to press 2-5 keys until the desired data file is retrieved.

This method also comprises a step 201 of encoding said word with a look-up table for generating an encoded data, said look-up table associating said symbols with a second set of symbols, each symbol of said second set of symbols being associated with a subset of said first set of symbols. When the user inputs his word, the word is encoded by step 201 with a look-up table for generating an encoded data. An example of a look-up table is illustrated by FIG. 4. A reduced keyboard may adopt the look-up table, where each key of the keyboard is associated with a subset of characters.

This method also comprises a searching step 202 of searching all data files that have index data 320 matching said encoded data.

There are two situations where said index data 320 match said encoded data. In one situation, said searching step 202 comprises a step of identifying (not shown) data files associated with index data 320, said index data 320 comprising said encoded data. For example, if a user wants to search the file entitled “ABC DEF GHI”, of which corresponding index data 320 are “111 122 223”, he may only know either ABC, DEF or GHI, then he can input ABC, or DEF or GHI, each corresponding encoded data being 111 or 122 or 223 respectively. Search algorithm will search the complete index data “111 122 223”. Because it finds said index data “111 122 223” comprising said encoded data “111” or “122” or “223”, it will identify all data files associating with index data 320, said index data 320 comprising said encoded data.

In another situation, said searching step 202 comprises a step of identifying (not shown) data files associated with index data 320, said index data 320 comprising a plurality of sets of symbols, the searching step 202 further comprising the steps of concatenating (not shown) all first symbols of said sets of symbols for generating a concatenated word; and comparing said concatenated word with said encoded data. Still taking the example above: the user wants to input every first letter of the title “ADG” (corresponding encoded data “112”) to locate the file, the search algorithm concatenates all first symbols of said sets of symbols (“111 222 333”) for generating a concatenated word “112” and comparing said concatenated word “112” with said encoded data “112”.

Furthermore, this invention provides a method comprising the step of triggering (not shown) said encoding step 201 and searching step 202 as soon as said word has been modified by said generating step. This is another aspect of the invention, whenever the user produces a single press, it will trigger said encoding step 201 and searching step 202 as soon as said word has been modified by said generating step.

The method as illustrated in FIG. 1 and FIG. 2 may advantageously be combined to form a method of manipulating data files stored in a storage unit, said method comprising the steps of extracting 100 a non-alphabetical data from said date file, said data being associated with said file; converting 101 said data into a word in using symbols taken from a first set of symbols; encoding 102 said word with a look-up table for generating index data 320, said look-up table associating said symbols with a second set of symbols, each symbol of said second set of symbols being associated with s subset of said first set of symbols; generating 200 a word in using symbols taken from said first set of symbols; encoding 201 said word with said look-up table for generating an encoded data; and searching 202 all data files that have index data 320 matching said encoded data, each of said data files being associated with said index data 320.

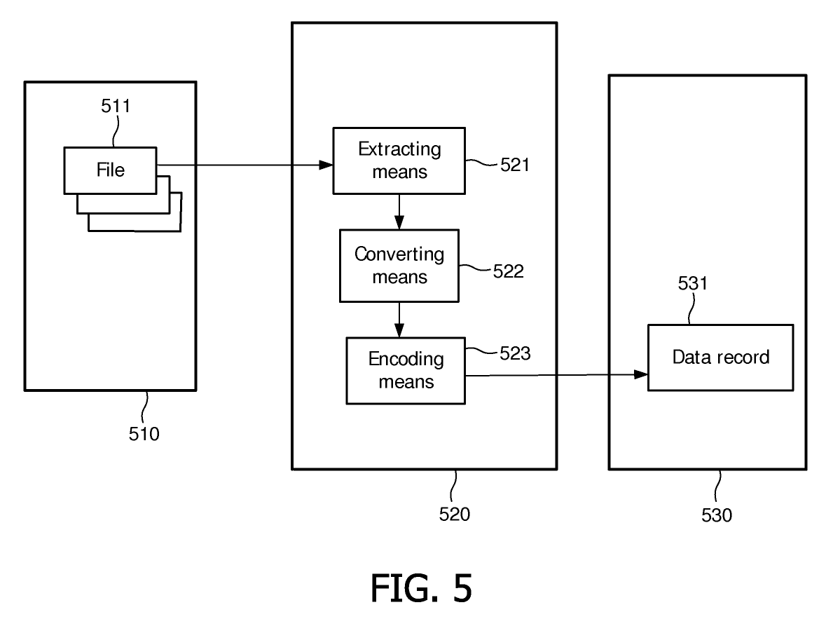

FIG. 5 represents an apparatus for encoding a data file stored in a storage unit according to the invention.

An apparatus 520 for encoding a file 511 stored in a storage unit, which file could be a media file such as an MP3 file, said apparatus comprising an extracting means 521 for extracting a non-alphabetical data from said file, converting means 522 for converting said non-alphabetical data into a word in using symbols taken from a first set of symbols; and encoding means 523 for encoding said word with a look-up table for generating index data 320, said look-up table associating said symbols with a second set of symbols, each symbol of said second set of symbols being associated with s subset of said first set of symbols.

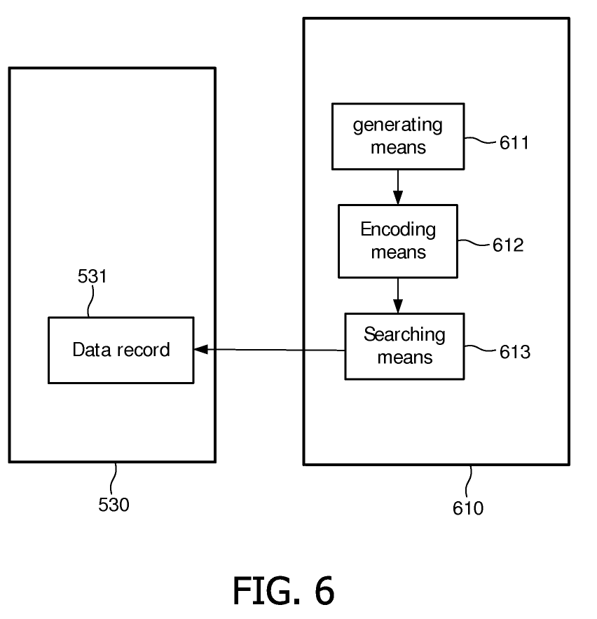

FIG. 6 represents an apparatus for retrieving data files stored in a storage unit according to the invention.

An apparatus 610 for retrieving data files stored in a storage unit, each of said files being associated with index data 320. Said apparatus comprises generating means 611 for generating a word in using symbols taken from a first set of symbols; encoding means 612 for encoding said word with a look-up table for generating an encoded data, said look-up table associating said symbols with a second set of symbols, each symbol of said second set of symbols being associated with a subset of said first set of symbols; and searching means 630 for searching all data files that have index data 320 matching said encoded data.

The apparatus as illustrated in FIG. 5 and FIG. 6 may advantageously be combined to form a system for manipulating data files stored in a storage unit, the apparatus comprising extracting means 521 for extracting a non-alphabetical data from said file; converting means 522 for converting said non-alphabetical data into a word in using symbols taken from a first set of symbols; encoding means 523 for encoding said symbol with a look-up table for generating index data 320, said look-up table associating said symbols with a second set of symbols, each symbol of said second set of symbols being associated with a subset of said first set of symbols; generating means 611 for generating a word in using symbols taken from said first set of characters; encoding means 612 for encoding said word with said look-up table for generating an encoded data; and searching means 613 for searching all data files that have index data 320 matching said encoded data.

It will be noted that the embodiments of the present invention described above are intended to be taken in an illustrative and non-limiting sense. Various modifications may be made to these embodiments by those skilled in the art without departing from the scope of the present invention.

1. A method of encoding a data file stored in a storage unit, said method comprising the steps of:
extracting (100) a non-alphabetical data from said data file, said data being associated with said file;
converting (101) said data into a word in using symbols taken from a first set of symbols; and
encoding (102) said word with a look-up table for generating index data (320), said look-up table associating said symbols with a second set of symbols, each symbol of said second set of symbols being associated with a subset of said first set of symbols.

2. A method as claimed in claim 1, wherein said non-alphabetical data is a metadata.

3. A method as claimed in claim 1, further comprising the steps of:
generating a data record, said data record comprising said index data (320) and a file pointer (330), said file pointer (330) linking said data record with said file;
storing said data record in a database.

4. A method as claimed in claim 3, further comprising the step of:
adding a tag (340) to said data record, said tag (340) classifying the content of said file.

5. A method as claimed in claim 3, further comprising the step of:
generating a plurality of data records, each of said data records containing a substring of said index data (320).

6. A method as claimed in claim 1, wherein said index data (320) comprise a plurality of sets of symbols, the method further comprising the step of:
generating a derived index data by concatenating each first symbol of each set of symbols.

7. A method of retrieving data files stored in a storage unit, each of said data files being associated with index data (320), said method comprising the steps of:
generating (200) a word in using symbols taken from a first set of symbols;
encoding (201) said word with a look-up table for generating an encoded data, said look-up table associating said symbols with a second set of symbols, each symbol of said second set of symbols being associated with a subset of said first set of symbols; and
searching (202) all data files that have index data (320) matching said encoded data.

8. A method as claimed in claim 7, wherein said searching step (202) comprises a step of identifying data files associated with index data (320), said index data (320) comprising said encoded data.

9. A method as claimed in claim 7, wherein said searching step (202) comprises a step of identifying data files associated with index data (320), said index data (320) comprise a plurality of sets of symbols, said method further comprising the steps of:
concatenating all first symbols of said sets of symbols for generating a concatenated word; and
comparing said concatenated word with said encoded data.

10. A method as claimed in claim 7, further comprising the step of:
triggering said encoding step (201) and searching step (202) as soon as said word has been modified by said generating step.

11. A method of manipulating data files stored in a storage unit, said method comprising the steps of:
extracting (100) a non-alphabetical data from said date file, said data being associated with said file;
converting (101) said data into a word in using symbols taken from a first set of symbols;
encoding (102) said word with a look-up table for generating index data (320), said look-up table associating said symbols with a second set of symbols, each symbol of said second set of symbols being associated with s subset of said first set of symbols;
generating (200) a word in using symbols taken from said first set of symbols;
encoding (201) said word with said look-up table for generating an encoded data; and
searching (202) all data files that have index data (320) matching said encoded data, each of said data files being associated with said index data (320).

12. An apparatus for encoding a data file stored in a storage unit, said apparatus comprising:
extracting means (521) for extracting a non-alphabetical data from said data file (511), said data being associated with said file (511);
converting means (522) for converting said data into a word in using symbols taken from a first set of symbols; and
encoding means (523) for encoding said word with a look-up table for generating index data (320), said look-up table associating said symbols with a second set of symbols, each symbol of said second set of symbols being associated with a subset of said first set of symbols.

13. An apparatus for retrieving data files stored in a storage unit, each of said data files being associated with index data (320), said apparatus comprising:
generating means (611) for generating a word in using symbols taken from a first set of symbols;
encoding means (612) for encoding said word with a look-up table for generating an encoded data, said look-up table associating said symbols with a second set of symbols, each symbol of said second set of symbols being associated with a subset of said first set of symbols; and
searching means (613) for searching all data files that have index data (320) matching said encoded data.

14. A system for manipulating data files stored in a storage unit, the system comprising:
extracting means (521) for extracting a non-alphabetical data from said file, said data being associated with said file;
converting means (522) for converting said data into a word in using symbols taken from a first set of symbols;
encoding means (523) for encoding said word with a look-up table for generating index data (320), said look-up table associating said symbols with a second set of symbols, each symbol of said second set of symbols being associated with s subset of said first set of symbols;
generating means (611) for generating a word in using symbols taken from said first set of symbols;
encoding means (612) for encoding said word with said look-up table for generating an encoded data; and
searching means (613) for searching all data files that have index data (320) matching said encoded data.
